(19) United States
(12) Patent Application Publication
(10) Pub. No.: US 2002/0041320 A1
(43) Pub. Date: Apr. 11, 2002

(54) Thermal Head

(76) Inventor: Osamu Takizawa, Chiba-shi (JP)

Correspondence Address: ADAMS & WILKS, 50 BROADWAY, 31ST FLOOR, NEW YORK, NY, 10004, US

(21) Appl. No.: 09/903,599

(22) Filed: Jul. 12, 2001

(30) Foreign Application Priority Data
Jul. 25, 2000 (JP) 2000-223579

(51) Int. Cl. B41J 2/32

(52) U.S. Cl. 347/171; 219/543

(57) ABSTRACT

An object of the present invention is to provide an edge type thermal head having high degree of freedom of the thermal radiation characteristic, a low manufacturing cost, and a high mass productivity, for example, a polyimide resin sheet having high flexibility is used as a substrate, a heating resistor, a separate electrode, a signal input electrode, and a protective film are formed and patterned on one surface of the substrate by using a sputtering process, a photo lithography process, and the like, a heating element drive element is mounted on the same surface, the separate electrode and the signal input electrode are electrically coupled with each other, the drive element and an electrically coupled region are protected by a resin adhesive, a resultant substrate is adhered to a rigid body made of resin, metal, and the like, for example, a flat plate in which beveling is made, and thus a thermal head is constructed.

### BACKGROUND OF THE INVENTION

1. Field of the Invention

The present invention relates to a structure of a thermal head.

2. Description of the Related Art

In the case where printing is performed for a hard print medium such as a card, even if a medium to be printed is in a flat state, in order to make a heating resistor to be in contact with the print medium, an edge type thermal head or a near edge type thermal head, in which the heating resistor is arranged near the edge, or a thermal head with a metal substrate in which a thickness is partially changed as shown in Japanese Patent Application Laid-open No. Hei 11-138879 is used.

As shown in FIG. 6, in the edge type thermal head, a glaze layer 2 and a heating portion 4 are provided in the edge of a substrate 1. Also, as shown in FIG. 7, in the near edge type thermal head, a glaze layer 2 and a heating portion 4 are provided on a slant surface 10 formed by slantly processing the edge of a substrate 1.

As shown in FIG. 8, in the thermal head formed in the metal substrate, glaze layers are provided on both surfaces of the metal substrate 11. A separate electrode 6 and a protective layer 7 are provided in a portion 20 in which a substrate thickness is thin. A partial glaze layer 2a and a heating portion 4 are provided in a portion 21 in which the substrate thickness is thick.

With respect to the edge type thermal head in which the heating resistor is arranged near the edgy, a side edge portion of a substrate is processed and a heating portion is formed in the edge portion. Thus, since a large number of items cannot be obtained from a large size substrate, there is a problem in that a cost per item becomes higher. In addition, when the heating portion is formed in the side surface of the substrate, since each electrode is separately formed on the upper surface and the side surface of the substrate, the number of processes for film formation and photolithography is increased. Further, it is difficult in view of a manufacturing technique to form the electrodes on the upper surface portion and the side surface without a break, and thus there is a problem in that the number of manufacturing processes is increased.

Also, with respect to the thermal head formed in the metal substrate, the electrode is formed on an insulating layer such as the glaze layer. Thus, there is a limiting condition that a curvature for curving the metal substrate cannot be made small. In addition, when a distortion due to tension and shrinkage is caused in a region in which the heating element is formed, there is a problem in that a heating resistance value is varied and a pulse resistant life is reduced. When the above distortion is applied to an IC mounted portion, a problem is caused such that an IC is separated or malfunctions.

Also, if a material of the substrate in which the thermal head is formed is limited to ceramic, metal, or the like, since the heat radiation characteristic of the thermal head is greatly influenced by the property of the substrate material, degree of freedom of the heat radiation characteristic becomes lower. Since the ceramic and the metal have a high thermal conductivity, there is a problem in that these materials are not suitable to a thermal head having a high thermal storage characteristic.

Also, when the thermal storage characteristic is intentionally adjusted, a thickness, a shape, and a construction area (the entire surface or a portion) of a glaze layer provided on a ceramic substrate or the like are used as control factors. However, if a step of the glaze layer becomes larger or the surface of the ceramic substrate is exposed as a partial glaze, there is a problem in that minute patterning becomes difficult.

### SUMMARY OF THE INVENTION

The present invention has been made in view of the above problems, and an object of the present invention therefore to provide an edge type thermal head having high degree of freedom of the thermal radiation characteristic, a low manufacturing cost, and a high mass productivity.

A first aspect of the present invention is a thermal head characterized in that, for example, a polyimide resin sheet having high flexibility is used as a substrate, a heating resistor, a separate electrode, a signal input electrode, and a protective film are formed and patterned on one surface of the substrate by using a sputtering process, a photo lithography process, and the like, a heating element drive element is mounted on the same surface, the separate electrode and the signal input electrode are electrically coupled with each other, the drive element and an electrically coupled region are protected by a resin adhesive, and a resultant substrate is adhered to a rigid body made of resin, metal, and the like, for example, a flat plate in which beveling is made.

A second aspect of the present invention is a thermal head characterized in that the rigid body is made from a member having a thermal conductivity of 0.03 to 240 W/m·K.

A third aspect of the present invention is a thermal head characterized in that the flexible substrate is made from a member having a thickness of 7 to 125 μm.

### BRIEF DESCRIPTION OF THE DRAWINGS

In the accompanying drawings:

FIG. 1 is a side view of a thermal head of the present invention with a state that it is adhered to a rigid body;

FIG. 2 is a schematic side view of the sheet-shaped thermal head;

FIG. 3 is a schematic front view of the sheet-shaped thermal head;

FIG. 4 is a schematic view of a sheet for obtaining a large number of items;

FIG. 5 is a view showing a thermal head in which a hollow is formed in the rigid body;

FIG. 6 is a view showing a conventional edge type thermal head;

FIG. 7 is a view showing a conventional near edge type thermal head; and

FIG. 8 is a view showing a conventional thermal head using a metal plate as a base.

### DETAILED DESCRIPTION OF THE PREFERED EMBODIMENTS

Hereinafter, an embodiment of the present invention will be described in details with reference to the drawings.

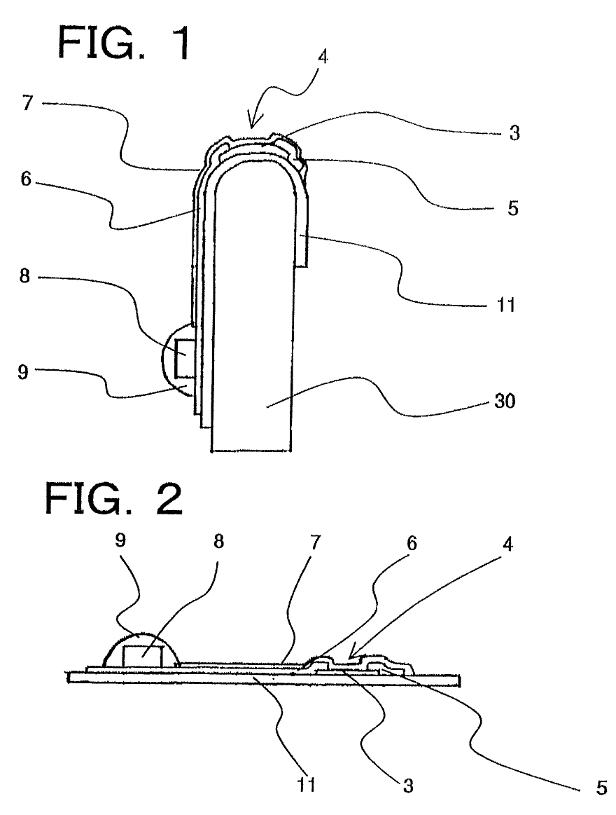

FIG. 1 is a schematic cross sectional view of a thermal head according to one embodiment of the present invention. As shown in FIG. 1, the thermal head has a flexible substrate 11 made of polyimide or the like and a rigid body 30. In the flexible substrate 11, a plurality of thin film layers are formed and a heating drive IC 8 is mounted.

A schematic cross sectional view of the flexible substrate 11 is shown in FIG. 2. In the flexible substrate 11, the plurality of thin film layers and the heating drive IC 8 are mounted. First, resistors 3 are intermittently formed on the flexible substrate 11 along a longitudinal direction at predetermined intervals. Electrodes 5 and 6 made of metal such as copper is formed so as to be in contact with the edges (both right end and left end in the drawing) of the respective heating elements 3. The electrode located in the right side in the drawing is a common electrode 5 and the electrode in the left side is a separate electrode 6. Further, a protective film 7 is formed in the top of the heating elements 3. In a left side of the separate electrode 6 in the drawing, the drive IC 8 is electrically coupled with the separate electrode 6 by flip chip bonding or the like and a resin 6 (9?) made of epoxy or the like is applied so as to protect the IC 8 and an electrically coupled region. In this structure, the glaze layer is not formed on the flexible substrate. Thus, with a state such that the flexible substrate 11 is bent, the occurrence of a crack, a chip, or the like in the glaze layer can be prevented.

On the other hand, with respect to the rigid body 30, beveling processing is required such that the edge portion to which the heating portion 4 is adhered does not have an acute angle and is rounded. As a beveling radius is larger, a distortion stress in the thin film near the heating portion 4 provided on the flexible substrate 11, is less. Thus, it is advantage in the case where a pulse resistant life and the like are kept. Although it is influenced by the thicknesses of the flexible substrate 11 and the thin film or the like, the beveling with a radius of about 0.5 mm is the limitation in the case of keeping the reliability.

Then, the flexible substrate 11 in which the plurality of thin films are formed and the drive IC 8 is mounted and the rigid body 30 are adhered to each other by using a double-faced tape or an adhesive to obtain the edge type thermal head. Also, as an adhesion method, in the case where the rigid body 30 made of a material such as a resin and the flexible substrate 11 made of a material of a polyimide sheet are selected, the surfaces of the above materials may be melted to adhere them.

In addition, when the thermal head is adhered to the rigid body, since the substrate having high flexibility is used, the adhesion along the outer shape of the rigid body can be made. At this time, in the case where the rigid body has an edge, when the sheet-shaped thermal head is adhered thereto such that the heating resistors are arranged in the edge, the edge type thermal head can be easily manufactured. Since the sheet has superior flexibility, a stress due to a bend in the heating resistors, the electrodes, and the protective film, in which are formed on the surface of the sheet, is extremely less. Thus, when the electrically coupled region of the drive element is arranged on the flat surface of the rigid body, the stress by bending the sheet can be eliminated.

With respect to the thermal head obtained by the above structure, when the shape of the rigid body 30 is changed without changing the flexible substrate 11, the thermal head having an arbitrary shape can be obtained. For example, a cylindrical thermal head can be easily obtained by adhering the flexible substrate to a cylindrical rigid body 30. Also, when the beveling radius of the rigid body 30 is set as described above, a triangular thermal head and a rectangular thermal head can be easily obtained. Further, the flexible substrate can be directly adhered to a printer case itself.

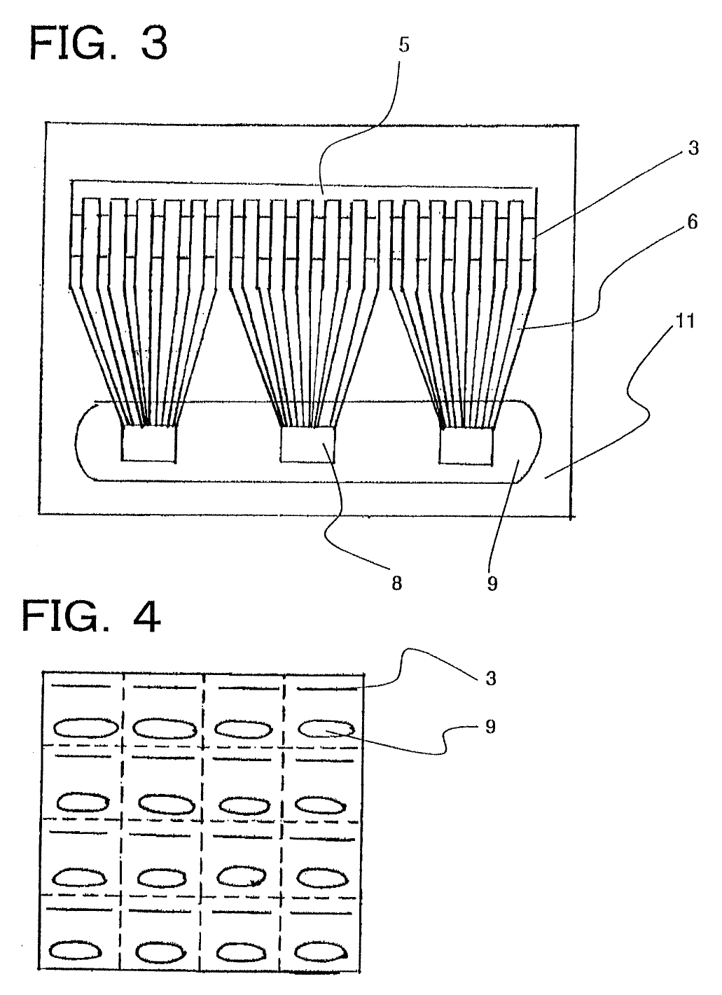

Next, a method of manufacturing the thermal head will be described. FIG. 3 is a schematic top view of one flexible substrate 11 in which a plurality of thin films before it is adhered to the rigid body 30 are formed and the drive IC 8 is mounted. On the flexible substrate 11, the resistors 3 are intermittently formed along a longitudinal direction at predetermined intervals and the drive IC 8 is mounted in a lower region of the drawing and molded by the resin 9. As described above, the film formation process and the mounting process are performed on the flat surface. Therefore, when an area of the polyimide sheet used as the flexible substrate is expanded as shown in FIG. 4, a large number of thermal heads can be obtained and thus the mass productivity becomes higher. In addition, since the glaze layer is not formed, unevenness on the flexible substrate is small and thus it is suitable for high minute patterning even in the photolithography process.

Since the thermal conductivity of the rigid body 30 can be greatly changed by changing a material of the rigid body, the thermal storage characteristic of the thermal head can be arbitrarily changed. Thus, with respect to the thermal head in which the thermal storage characteristic is improved, printing efficiency to input energy can be improved. In addition, when the thermal storage characteristic is reduced, high speed printing is allowed. Therefore, using the same thermal head, a thermal head having a different characteristic can be easily manufactured.

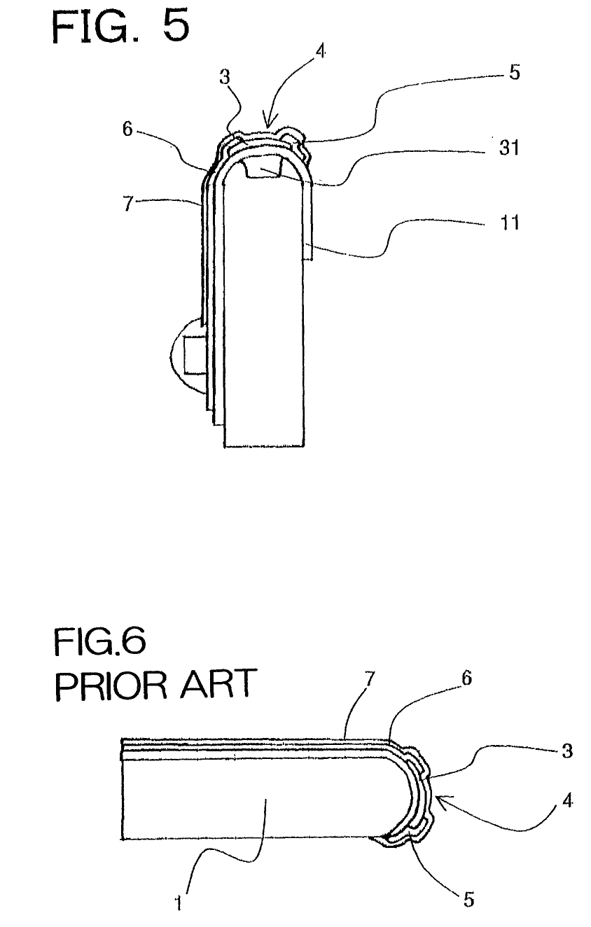

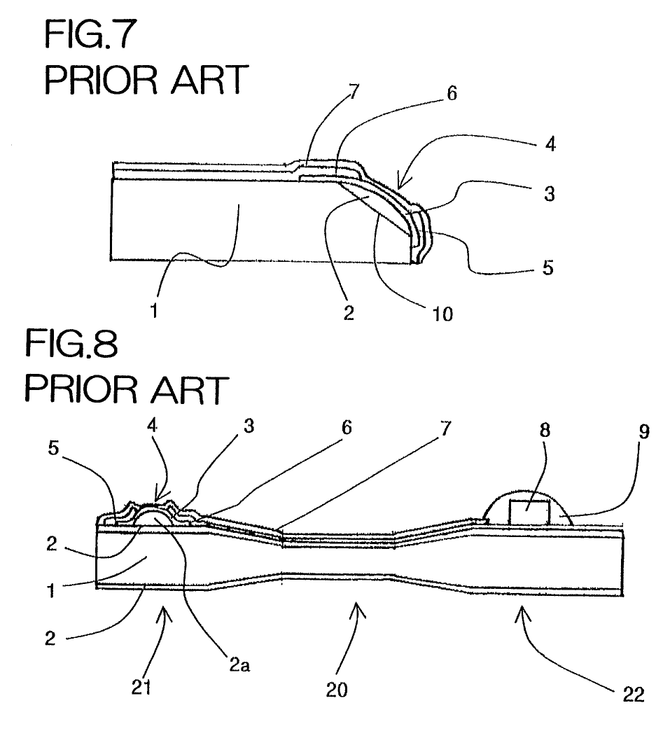

For example, in order to obtain a thermal head having a high thermal radiation characteristic, aluminum having a thermal conductivity of 240 W/mK is used as the rigid body 1. Thus, since the heat radiation of the heating portion 4 is improved, the thermal head in which a temperature is rapidly decreased and a thermal response is fast and which is suitable for high speed printing is obtained. On the other hand, in order to obtain a thermal head in which the thermal response is slow and the heat storage characteristic is high, a material having a porous surface is used such that the thermal conductivity is close to 0.029 W/mK as that of an air. Alternatively, as shown in FIG. 5, a thermal head may be used such that a hollow 31 is formed in a region of the rigid body 30, which corresponds to the rear surface of the heating portion 4. Therefore, the thermal storage characteristic of the heating portion 4 is greatly varied and thus the thermal response can be easily changed.

With respect to a substrate thickness of the flexible substrate, when the flexibility and the distortion stress due to a bend are considered, it is determined that its maximum value is about 125 μm. If the thickness is made thicker, the distortion stress is increased and thus stability of a resistance value and a pulse resistant life are influenced. In a conventional thermal head, since the thermal conductivity is 1.0 W/mK and the film thickness is 60 μm, a thermal resistance of the glaze layer becomes 6.0E7 m²K/W. In addition, when the flexible substrate is made of polyimide, since the thermal conductivity is 0.12 W/mK, it is required that the thickness is made to be 7 μm or thicker.

As described above, according to the present invention of claim 1, a large number of items can be obtained from the polyimide sheet having a large area and the mass productivity of the thermal head in which the heating resistors are arranged near the edge can be easily improved. According to the present invention of claim 2, when the same thermal head as claim 1 is used, a thermal head having from a high thermal storage characteristic until a low thermal conductivity can be selected by adjusting the thermal storage characteristic of the rigid body. According to the present invention of claim 3, even when the flexible substrate is bent, the stability in the resistance value of the heating element on the flexible substrate can be kept and the reduction in the pulse resistant life can be prevented.

What is claimed is:

1. A thermal head which includes a plurality of heating resistors, an electrode for supplying power to the heating resistors, and a drive element for selectively heating the heating resistors on an insulating flexible substrate and in which the flexible substrate is fixed to a heat radiation plate, characterized in that the flexible substrate is curved and fixed to the heat radiation plate such that the heating resistors are arranged in an edge portion of the heat radiation plate.

2. A thermal head according to claim 1, characterized in that the heat radiation plate is made from a member having a thermal conductivity of 0.03 to 240 W/m·K.

3. A thermal head according to claim 1, characterized in that the flexible substrate is made from a member having a thickness of 7 to 125 μm.
